(19) United States
(12) Patent Application Publication
(10) Pub. No.: US 2026/0331724 A1
(43) Pub. Date: Oct. 22, 2026

(54) SECONDARY BATTERY

(71) Applicant: TOYOTA JIDOSHA KABUSHIKI KAISHA, Toyota-shi (JP)

(72) Inventors: Kazuhito KATO, Toyota-shi (JP); Suguru IKEYAMA, Toyota-shi (JP); Yasuhiro SAKASHITA, Nisshin-shi (JP); Yosuke SHIMURA, Nagakute-shi (JP); Takahiko NAKANO, Nagoya-shi (JP); Tomofumi HIRUKAWA, Miyoshi-shi (JP)

(73) Assignee: TOYOTA JIDOSHA KABUSHIKI KAISHA, Toyota-shi (JP)

(21) Appl. No.: 19/536,484

(22) Filed: Feb. 11, 2026

(30) Foreign Application Priority Data
Apr. 18, 2025 (JP) 2025-068916

(51) Int. Cl. H01M 50/55; H01M 10/04; H01M 10/052; H01M 10/0585; H01M 10/0587

(52) U.S. Cl. CPC H01M 50/55; H01M 10/0431; H01M 10/052; H01M 10/0585; H01M 10/0587

(57) ABSTRACT

The secondary battery includes an electrode stack in which a plurality of electrodes, each including an electrode active material layer coated on at least one surface of a sheet-like current collector, is stacked in a first direction with a separator interposed between the electrodes. Each of the electrodes includes an uncoated portion that includes an edge of the current collector and where the electrode active material layer is not coated. The uncoated portion includes a proximal region and a distal region. The proximal region extends in a second direction intersecting the first direction from a coated portion where the electrode active material layer is coated on the current collector. The distal region includes the edge and is bent relative to the proximal region. The distal regions of the uncoated portions respectively included in the electrodes are joined to a terminal plate such that the distal regions overlap each other.

### CROSS-REFERENCE TO RELATED APPLICATION

This application claims priority to Japanese Patent Application No. 2025-068916 filed on Apr. 18, 2025. The disclosure of the above-identified application, including the specification, drawings, and claims, is incorporated by reference herein in its entirety.

### BACKGROUND

### 1. Technical Field

The technology disclosed in the present specification relates to secondary batteries.

### 2. Description of Related Art

Japanese Unexamined Patent Application Publication No. 2003-168415 (JP 2003-168415 A) discloses a secondary battery in which a cathode plate formed by coating a cathode material onto a cathode current collector and an anode plate formed by coating an anode material onto an anode current collector are wound together with a separator interposed therebetween to form an electrode assembly. According to JP 2003-168415 A, a portion of a cathode current collector where no cathode material is coated and that protrudes beyond the separator is plastically deformed to form a cathode flat portion, and a cathode current collector plate is joined to the cathode flat portion. Similarly, a portion of an anode current collector where no anode material is coated and that protrudes beyond the separator is plastically deformed to form an anode flat portion, and an anode current collector plate is joined to the anode flat portion.

Japanese Unexamined Patent Application Publication No. 11-354103 (JP 11-354103 A) discloses an electrode plate for a secondary battery in which multiple slits are formed in an uncoated portion of a current collector where no active material layer is coated. The slits extend in a direction that intersects the flow direction (i.e., the direction in which a coated portion, where the active material layer is formed during pressing, extends) and are arranged side by side. Japanese Unexamined Patent Application Publication No. 2000-208129 (JP 2000-208129 A) discloses a lithium secondary battery in which slits parallel to the width direction of a current collector substrate are formed in an uncoated region of the current collector substrate where no electrode active material layer is coated.

### SUMMARY

An electrode having an electrode active material layer coated on a surface of a sheet-shaped current collector is pressed at a predetermined pressure using a roller in order to increase the density of the electrode active material layer and to make its thickness uniform. A difference in elongation occurs between a coated portion of the current collector where the electrode active material layer is coated and an uncoated portion where no electrode active material layer is coated, when the electrode is pressed. This difference in elongation causes waviness or wrinkles (hereinafter simply referred to as "waviness etc.") to occur in the uncoated portion.

In this situation, the related art, including JP 2003-168415 A, JP 11-354103 A, and JP 2000-208129 A, has been insufficient in simultaneously suppressing such waviness etc. and ensuring that the uncoated portion functions appropriately for current collection.

The present specification discloses a secondary battery. The secondary battery includes an electrode stack in which a plurality of electrodes, each including an electrode active material layer coated on at least one surface of a current collector in the form of a sheet, is stacked in a first direction with a separator interposed between the electrodes. Each of the electrodes includes an uncoated portion that includes an edge of the current collector and where the electrode active material layer is not coated. The uncoated portion includes a proximal region and a distal region. The proximal region extends in a second direction intersecting the first direction from a coated portion where the electrode active material layer is coated on the current collector. The distal region includes the edge and is bent relative to the proximal region. The distal regions of the uncoated portions respectively included in the electrodes are joined to a terminal plate in a state in which the distal regions overlap each other.

In this configuration, the distal regions respectively included in the electrodes are joined to the terminal plate in a state in which the distal regions overlap each other. This allows the uncoated portion of each electrode to be reliably integrated with the terminal plate and to function as a current collecting portion. Since such integration ensures that the uncoated portion functions as the current collecting portion, the size of the uncoated portion can be made smaller than in conventional examples. Accordingly, the present embodiment suppresses waviness etc. in the uncoated portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an electrode sheet to be roll-pressed, as viewed from a direction facing one surface of the electrode sheet;

FIG. 2 is an enlarged view of an uncoated portion;

FIG. 3 is a side view of a secondary battery;

FIG. 4 is an enlarged view showing the state in which uncoated portions of a plurality of cathodes are joined to a cathode terminal plate;

FIG. 5 shows the cathode terminal plate as viewed from a direction opposite to that in which a cathode terminal portion protrudes;

FIG. 6 is an exploded perspective view of an electrode stack; and

FIG. 7 schematically shows an electrode sheet having notches, as viewed from the same direction as in FIG. 1.

### DETAILED DESCRIPTION OF EMBODIMENTS

The main features of an embodiment described below will first be described. These features may be combined as desired.

In the secondary battery disclosed in the present specification, the ratio of the length of the uncoated portion to the length of the coated portion, as measured along a direction in which the uncoated portion extends from the coated portion, may be 2.5% or less. In this configuration, by setting the ratio to as low as 2.5% or less, the uncoated portion itself can be made smaller, thereby suppressing waviness etc. in the uncoated portion.

In the secondary battery disclosed in the present specification, a joining line that joins a region where the distal regions overlap each other to the terminal plate may be provided along the first direction. With this configuration, the distal regions can be easily joined to the terminal plate.

In the secondary battery disclosed in the present specification, the region where the distal regions overlap each other and the terminal plate may be joined at a plurality of locations. This configuration increases the joining strength between the distal regions and the terminal plate.

In the secondary battery disclosed in the present specification, the region where the distal regions overlap each other and the terminal plate may be joined by a plurality of joining lines, and the joining lines may be arranged in a third direction that intersects the first direction and the second direction. This configuration further increases the joining strength between the distal regions and the terminal plate.

In the secondary battery disclosed in the present specification, the length of the proximal region may be shorter than the length of the distal region, as measured in the direction in which the uncoated portion extends from the coated portion. With this configuration, waviness etc. in the proximal region can be suppressed while more reliably ensuring that the distal region functions appropriately for current collection.

In the secondary battery disclosed in the present specification, the uncoated portion may have a notch that extends from the edge toward the coated portion. With this configuration, the notch in the uncoated portion further suppress waviness etc. in the uncoated portion.

An embodiment will now be described with reference to the drawings. The drawings are merely illustrative, and the embodiment is not limited to what is shown in the drawings. Since the drawings are illustrative, certain portions may be omitted for clarity.

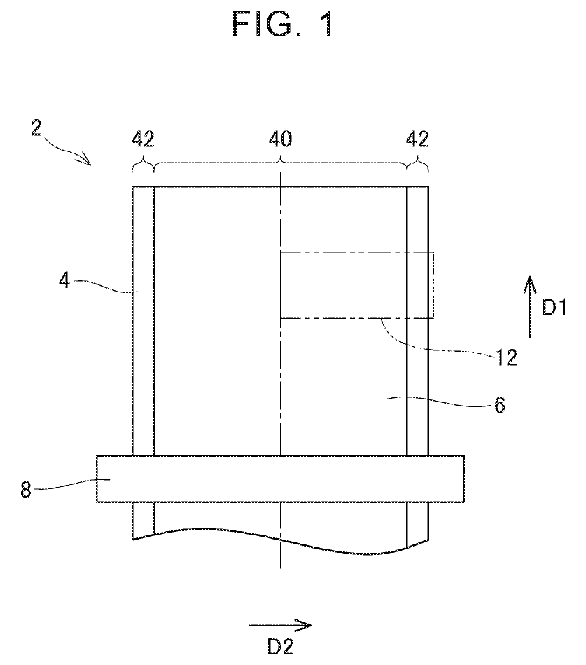

FIG. 1 schematically shows an electrode sheet 2 to be roll-pressed, as viewed from a direction facing one surface of the electrode sheet 2. The electrode sheet 2 includes a current collector 4 in the form of an elongated sheet and an electrode active material layer 6 coated on at least one surface of the current collector 4. The current collector 4 is a metal foil. The region of the current collector 4 where the electrode active material layer 6 is coated is referred to as "coated portion 40." The region of the current collector 4 where the electrode active material layer 6 is not coated is referred to as "uncoated portion 42." In FIG. 1, "D1" denotes the longitudinal direction of the electrode sheet 2, and "D2" denotes the width direction of the electrode sheet 2 that is perpendicular to the longitudinal direction D1. The electrode sheet 2 has uncoated portions 42 at both ends in the width direction D2.

As shown in FIG. 1, a long roller 8 extending in the width direction D2 comes into contact with the electrode sheet 2 as the electrode sheet 2 is conveyed along the longitudinal direction D1. To increase the density of the electrode active material layer 6 and to make its thickness uniform, the electrode sheet 2 is roll-pressed under a predetermined pressure using the roller 8. A difference in elongation occurs between the coated portion 40 and the uncoated portion 42 when the electrode sheet 2 is pressed, and this difference in elongation causes waviness etc. in the uncoated portion 42.

To address this issue, the uncoated portion 42 is made smaller in the present embodiment than in conventional examples. In FIG. 1, the size of one electrode 12 is shown by the region enclosed by a long dashed double-short dashed line. After the roll-pressing, the electrode sheet 2 is cut and separated into a plurality of electrodes 12 each having, for example, the size shown in FIG. 1.

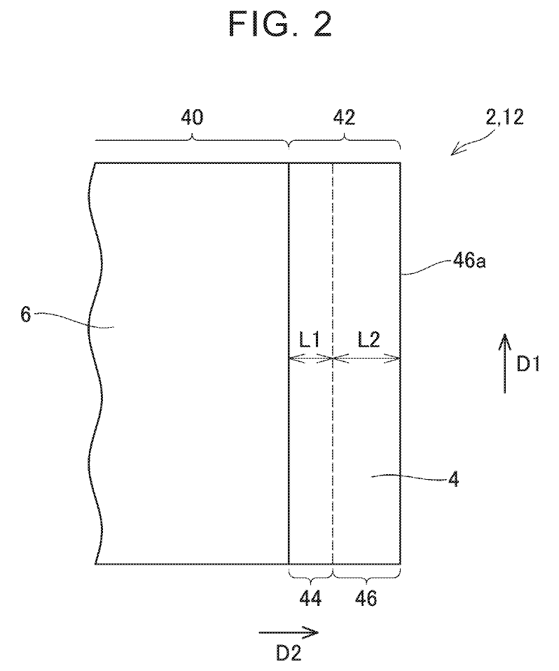

FIG. 2 is an enlarged view of the uncoated portion 42 as viewed from the same direction as in FIG. 1. Although FIG. 2 shows a portion of the electrode sheet 2, this may be regarded as a portion of a single electrode 12. Focusing on one electrode 12, for example, the ratio of the length of the uncoated portion 42 to the length of the coated portion 40 measured along the direction in which the uncoated portion 42 extends from the coated portion 40 (the width direction D2 in FIGS. 1 and 2) is 2.5% or less. For example, the length of the coated portion 40 of the electrode 12 in the width direction D2 is 200 mm or more, and the length of the uncoated portion 42 of the electrode 12 in the width direction D2 is 5 mm or less. By reducing the size of the uncoated portion 42 itself in this manner, for example, by setting the above ratio to as low as 2.5% or less, waviness etc. in the uncoated portion 42 can be suppressed.

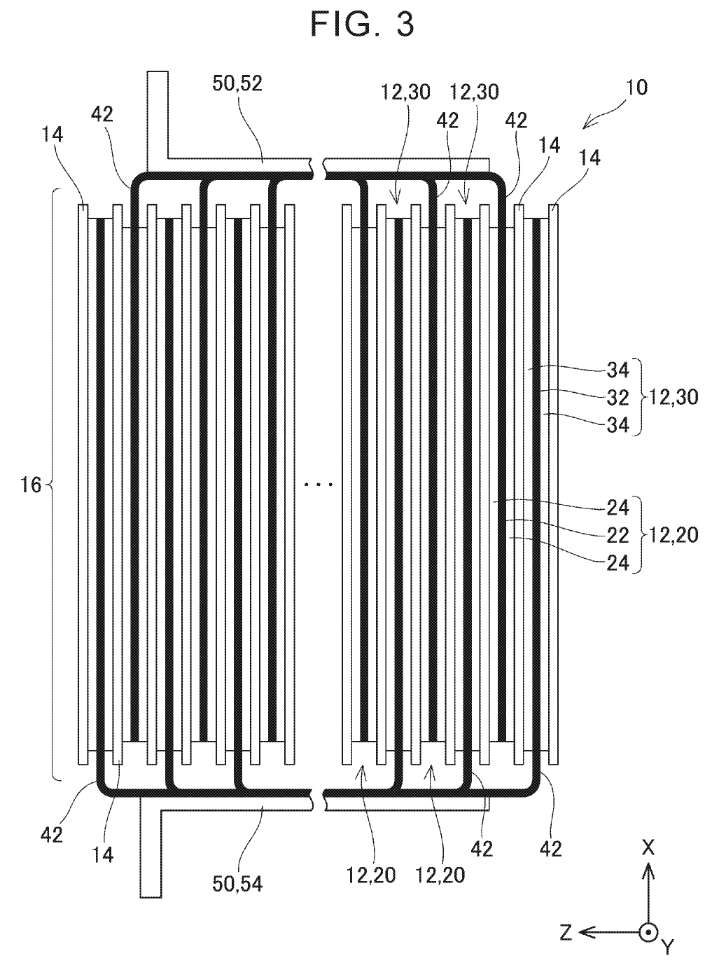

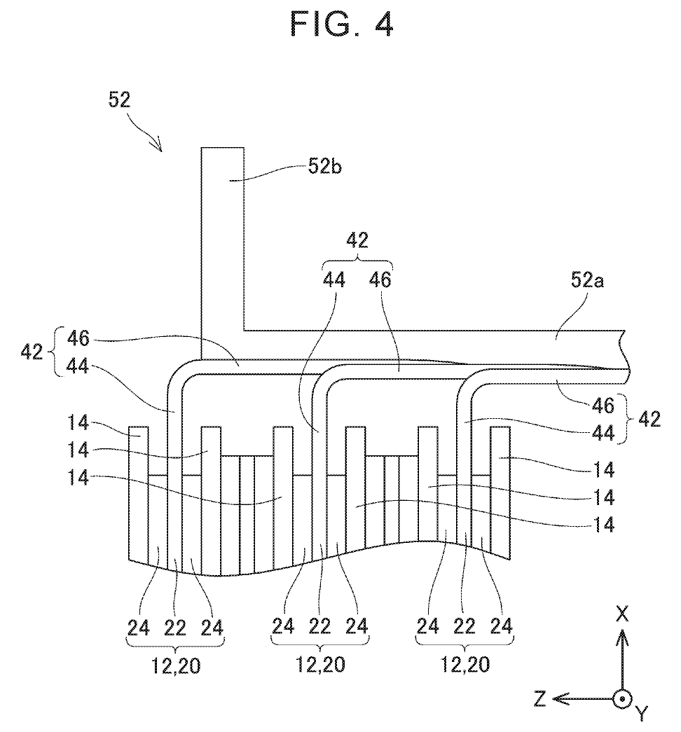

As shown in FIG. 2, the electrode 12 includes the uncoated portion 42 including an edge 46a of the current collector 4. A region of the uncoated portion 42 located closer to the coated portion 40 is referred to as "proximal region 44," and a region of the uncoated portion 42 including the edge 46a and located farther from the coated portion 40 is referred to as "distal region 46." That is, the proximal region 44 is connected to the coated portion 40 and is located between the coated portion 40 and the distal region 46. When measured along the direction in which the uncoated portion 42 extends from the coated portion 40 (the width direction D2 in FIGS. 1 and 2), the length L1 of the proximal region 44 is shorter than the length L2 of the distal region 46. In the state shown in FIGS. 1 and 2, the uncoated portion 42 extends straight in the width direction D2, like the coated portion 40. However, as shown in FIGS. 3 and 4, the electrode 12 is used in a state where the distal region 46 is bent relative to the proximal region 44. Accordingly, in the present embodiment, the "direction in which the uncoated portion 42 extends from the coated portion 40" is not limited to a straight direction and may also include a curved or changing direction.

FIG. 3 schematically shows the secondary battery 10 as viewed from one side. The secondary battery 10 may be, for example, a rechargeable lithium-ion battery. The electrodes 12 are used as part of the structure of the secondary battery 10. The secondary battery 10 includes an electrode stack 16 formed by stacking the electrodes 12 in a first direction with a separator 14 interposed therebetween. The electrodes 12 include a cathode 20 and an anode 30. The secondary battery 10 includes an outer casing (not shown), and the electrode stack 16 is sealed inside the outer casing. An electrolyte solution (not shown) is also contained inside the outer casing. The outer casing may be, for example, a laminate sheet. For convenience of description, FIGS. 3-6 show X-, Y-, and Z-axes that are perpendicular to each other. The Z-axis corresponds to the first direction. The first direction may also be referred to as "stacking direction."

The electrode stack 16 is formed by alternately stacking substantially rectangular cathodes 20 and substantially rectangular anodes 30 with the separator 14 interposed therebetween. Each of the cathode 20 and the anode 30 extends in the X-axis and Y-axis directions. For the electrodes 12, the X-axis direction corresponds to the width direction D2 shown in FIGS. 1 and 2. The separator 14 is formed of a material that provides both permeability that allows movement of charge carriers (in this case, lithium ions) during charging and discharging, and insulation that suppresses short-circuiting caused by contact between the cathode 20 and the anode 30. Examples of materials for the separator 14 include polypropylene and polyethylene.

The cathode 20 includes a cathode current collector 22 and a cathode active material layer 24 coated on the cathode current collector 22. The cathode current collector 22 is an example of the current collector 4, and the cathode active material layer 24 is an example of the electrode active material layer 6. The cathode active material layer 24 is coated, for example, on both surfaces of the cathode current collector 22. The cathode current collector 22 is, for example, an aluminum foil. The cathode active material layer 24 contains a cathode active material. Examples of cathode active materials include lithium nickel composite oxides, lithium cobalt composite oxides, and lithium manganese composite oxides.

The anode 30 includes an anode current collector 32 and an anode active material layer 34 coated on the anode current collector 32. The anode current collector 32 is an example of the current collector 4, and the anode active material layer 34 is an example of the electrode active material layer 6. The anode active material layer 34 is coated on, for example, both surfaces of the anode current collector 32. The anode current collector 32 is, for example, a copper foil. The anode active material layer 34 contains an anode active material. Examples of anode active materials include carbon materials such as graphite, hard carbon, and soft carbon; materials such as silicon (Si) that form alloys with lithium; and lithium alloys. The electrode active material may be formed of a single material or may be formed of multiple materials. The electrode active material layer may also contain a conductive additive, a binder, etc.

Each electrode 12 (the cathode 20 and the anode 30) has an uncoated portion 42 that protrudes in a second direction intersecting the first direction. The X-axis direction (the +X- and −X-directions) corresponds to the second direction. As shown in FIG. 3, the uncoated portions 42 of the multiple cathodes 20 protrude in the +X-direction, and the uncoated portions 42 of the multiple anodes 30 protrude in the −X-direction. The uncoated portions 42 of the cathodes 20 and the uncoated portions 42 of the anode 30 protrude in opposite directions and extend outward beyond the region sandwiched between the separators 14. After the electrode stack 16 is formed, a cathode terminal plate 52, which is one of terminal plates 50, is joined to the uncoated portions 42 of the cathodes 20 at a position outside the separator 14. Similarly, an anode terminal plate 54, which is another one of the terminal plates 50, is joined to the uncoated portions 42 of the anodes 30 at a position outside the separator 14.

FIG. 4 is an enlarged view, relative to FIG. 3, showing the state in which the uncoated portions 42 of the cathodes 20 are joined to the cathode terminal plate 52. As shown in FIG. 4, the proximal region 44 of the uncoated portion 42 extends along the second direction (the X-axis direction), and the distal region 46 of the uncoated portion 42 is bent relative to the proximal region 44. The distal region 46 is bent substantially perpendicularly to the proximal region 44. The distal regions 46 of the uncoated portions 42 of the electrodes 12 (in FIG. 4, the cathodes 20) are joined to the terminal plate 50 (in FIG. 4, the cathode terminal plate 52) in such a manner that the distal regions 46 overlap each other.

As shown in FIGS. 3 and 4, the terminal plate 50 is a generally L-shaped metal plate. As shown in FIG. 4, the cathode terminal plate 52 includes a joining portion 52a that is substantially parallel to the Z-axis direction, and a cathode terminal portion 52b that is bent substantially perpendicular to the joining portion 52a and protrudes away from the proximal regions 44. The overlapping distal regions 46 are joined to the joining portion 52a in such a manner that they are in surface contact with the joining portion 52a.

As described above, in the present embodiment, the distal regions 46 respectively corresponding to the electrodes 12 are joined to the terminal plate 50 in such a manner that the distal regions 46 overlap each other. This allows the uncoated portion 42 of each electrode 12 to be reliably integrated with the terminal plate 50 and to function as a current collecting portion electrically connected to the terminal. Compared with the configuration disclosed in JP 2003-168415 A in which the uncoated portions of the current collectors on the respective electrode plates are joined to a current collecting plate at such positions that the uncoated portions are separated from each other, the configuration in which the distal regions 46 are joined to the terminal plate 50 in such a manner that the distal regions 46 overlap each other enables the uncoated portion 42 of each electrode 12 to be more reliably electrically connected to the terminal plate 50. Since such integration ensures that the uncoated portion 42 functions as a current collecting portion, the size of the uncoated portion 42 can be made smaller than in conventional examples. Accordingly, the present embodiment suppresses waviness etc. in the uncoated portion 42. Furthermore, in the present embodiment, the length L1 of the proximal region 44 is shorter than the length L2 of the distal region 46. This minimizes waviness etc. in the proximal region 44 while allowing the distal region 46 to be reliably joined to the terminal plate 50 and to function appropriately for current collection.

As described above, the length of the uncoated portion 42 including the proximal region 44 and the distal region 46 and protruding from the coated portion 40 is, for example, 5 mm or less. The length of the uncoated portion 42 may be approximately 1 mm to 2 mm. The thickness of the electrode 12 is, for example, approximately 0.2 mm to 0.3 mm. Accordingly, with the length of the uncoated portion 42 being set to about 1 mm to 2 mm, each of the distal regions 46 of the uncoated portions 42 (for example, the uncoated portions 42 of the cathodes 20) that respectively protrude from the stacked electrodes 12 can readily overlap one or more other distal regions 46 when the distal regions 46 are bent, even in consideration of the thickness of the separator 14.

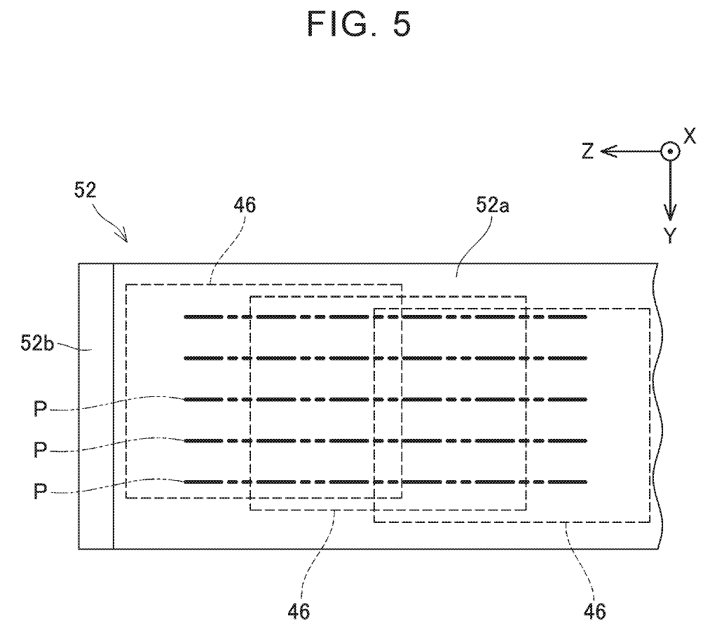

FIG. 5 shows the cathode terminal plate 52 as viewed from a direction opposite to that in which the cathode terminal portion 52b protrudes. In FIG. 5, the respective areas of the distal regions 46 that are joined to the joining portion 52a are shown by dashed lines. In order to clearly show that the distal regions 46 overlap each other, the distal regions 46 are shown offset in the Y-axis direction in FIG. 5. However, in practice, there is no such offset in the Y-axis direction. In FIG. 5, joining lines P that join the region where the distal regions 46 overlap each other to the cathode terminal plate 52 are shown as long dashed double-short dashed lines. At the joining lines P, the distal regions 46 are joined to the joining portion 52a, for example, by welding or adhesion. As shown in FIG. 5, the joining lines P are formed along the first direction (the Z-axis direction). As can be seen from FIGS. 3 and 4, the distal region 46 of each uncoated portion 42 is bent toward the Z-axis direction (the +Z- or −Z-direction). Accordingly, forming the joining lines P along the first direction allows the distal regions 46 and the terminal plate 50 to be joined more easily and reliably.

As shown in FIG. 5, multiple joining lines P are formed. In other words, the region where the distal regions 46 overlap each other and the cathode terminal plate 52 are joined at multiple locations. This configuration increases the joining strength between the distal regions 46 and the terminal plate 50. Furthermore, as shown in FIG. 5, the joining lines P are arranged in a third direction (the Y-axis direction) that intersects the first direction (the Z-axis direction) and the second direction (the X-axis direction). This configuration further increases the joining strength between the distal regions 46 and the terminal plate 50.

The manner in which the distal regions 46 are joined to the terminal plate 50 is not limited to the example described above. For example, at least one joining line P may be inclined relative to the first direction, or may be parallel to the third direction. The multiple joining lines P may intersect in a lattice pattern or in an X-shaped pattern. Alternatively, at least one joining line P may be a curved line or a line including a bend(s). Alternatively, at least one joining line P may be discontinuous, with spaced joining segments that connect the distal regions 46 to the terminal plate 50. The description of the present embodiment regarding the joining of the distal regions 46 of the uncoated portions 42 of the cathodes 20 to the cathode terminal plate 52 also applies to the joining of the distal regions 46 of the uncoated portions 42 of the anodes 30 to the anode terminal plate 54.

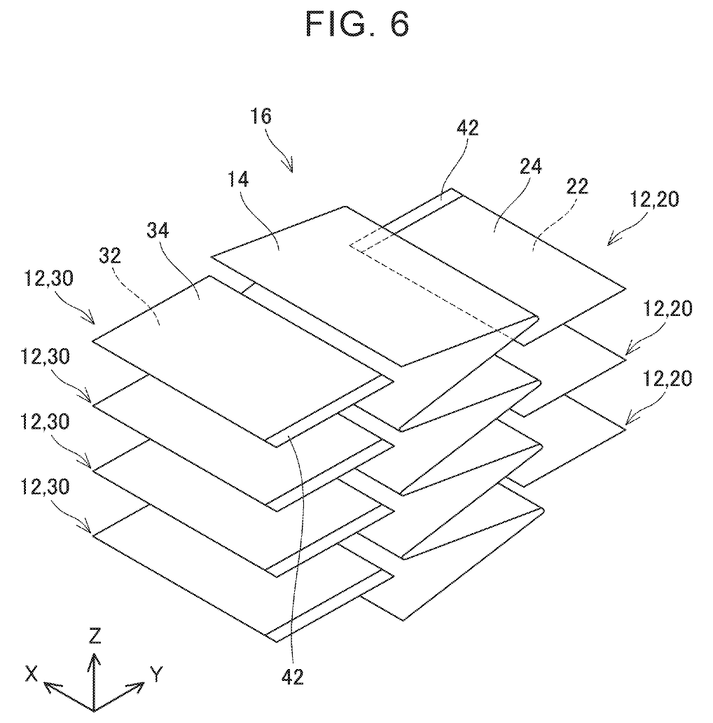

FIG. 6 is a schematic exploded perspective view of the electrode stack 16. The electrode stack 16 is formed, for example, by alternately stacking the cathodes 20 and the anodes 30 such that a strip-shaped separator 14 folded in an accordion manner with alternating mountain and valley folds is interposed therebetween. In this configuration, each of the cathodes 20 is sandwiched between two surfaces on one side of the folded separator 14, while each of the anodes 30 is sandwiched between two surfaces on the other side of the folded separator 14. In FIG. 6, the uncoated portions 42 of the cathodes 20 and the uncoated portions 42 of the anodes 30 are each shown in a state before their respective distal regions 46 are bent. The configuration in which a continuous separator 14 folded in an accordion manner is interposed between the electrodes 12 as shown in FIG. 6 is merely an example. The separators 14 interposed between the electrodes 12 may be provided as separate sheets.

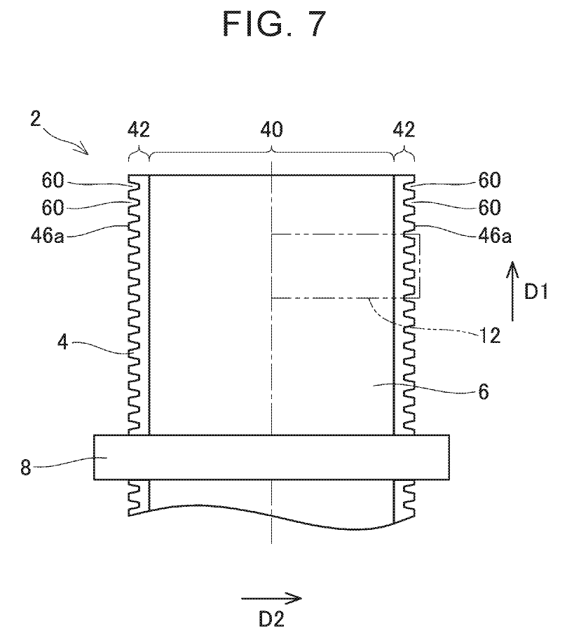

Like FIG. 1, FIG. 7 shows the electrode sheet 2 to be roll-pressed. Only the differences from FIG. 1 will be described for FIG. 7. As shown in FIG. 7, notches 60 are formed in the uncoated portions 42 so as to extend from the edges 46a (one end and the other end) of the current collector 4 toward the coated portion 40. Each notch 60 extends through the current collector 4 and is open at the edge 46a. Multiple notches 60 are formed, for example, at regular intervals along the longitudinal direction D1 of the electrode sheet 2. The notches 60 may or may not extend to the coated portion 40. For example, the notches 60 may be formed in the distal region 46 of the uncoated portion 42 but not in the proximal region 44. In another example, the notches 60 may be formed in both the distal region 46 and the proximal region 44. The notches 60 formed in the uncoated portions 42 function to suppress waviness etc. caused by the difference in elongation between the coated portion 40 and the uncoated portion 42 when the electrode sheet 2 is roll-pressed. Accordingly, waviness etc. in the uncoated portion 42 are further suppressed.

Although specific examples of the technology disclosed in the present specification have been described in detail above, these examples are merely illustrative and do not limit the scope of the claims. The technology described in the claims includes various modifications and variations of the specific examples illustrated above. The technical elements described in the present specification and the drawings exhibit technical utility either individually or in various combinations, and are not limited to the combinations described in the claims as originally filed. The technology illustrated in the present specification and the drawings achieve multiple objectives simultaneously, and achieving even one of these objectives alone provides technical utility.

What is claimed is:

1. A secondary battery comprising an electrode stack in which a plurality of electrodes, each including an electrode active material layer coated on at least one surface of a current collector in a form of a sheet, is stacked in a first direction with a separator interposed between the electrodes, wherein:
each of the electrodes includes an uncoated portion that includes an edge of the current collector and where the electrode active material layer is not coated;
the uncoated portion includes a proximal region and a distal region, the proximal region extending in a second direction intersecting the first direction from a coated portion where the electrode active material layer is coated on the current collector, and the distal region including the edge and being bent relative to the proximal region; and
the distal regions of the uncoated portions respectively included in the electrodes are joined to a terminal plate in a state in which the distal regions overlap each other.

2. The secondary battery according to claim 1, wherein a ratio of a length of the uncoated portion to a length of the coated portion, as measured along a direction in which the uncoated portion extends from the coated portion, is 2.5% or less.

3. The secondary battery according to claim 1, wherein a joining line that joins a region where the distal regions overlap each other to the terminal plate is provided along the first direction.

4. The secondary battery according to claim 1, wherein a region where the distal regions overlap each other and the terminal plate are joined at a plurality of locations.

5. The secondary battery according to claim 4, wherein the region where the distal regions overlap each other and the terminal plate are joined by a plurality of joining lines, and the joining lines are arranged in a third direction that intersects the first direction and the second direction.

6. The secondary battery according to claim 1, wherein a length of the proximal region is shorter than a length of the distal region, as measured in a direction in which the uncoated portion extends from the coated portion.

7. The secondary battery according to claim 1, wherein the uncoated portion has a notch that extends from the edge toward the coated portion.
